(19) United States
(12) Patent Application Publication
(10) Pub. No.: US 2018/0335168 A1
(43) Pub. Date: Nov. 22, 2018

(54) GROMMET

(71) Applicant: BOMBARDIER INC., Dorval (CA)

(72) Inventors: Sylvain BRAIS, Vaudreuil-Dorion (CA); Mathieu DESJARDINS, Montreal (CA)

(21) Appl. No.: 15/777,461

(22) PCT Filed: Nov. 15, 2016
(86) PCT No.: PCT/IB2016/056873

§ 371 Date: May 18, 2018

Related U.S. Application Data
(60) Provisional application No. 62/258,690, filed on Nov. 23, 2015.

(51) Int. Cl. F16L 5/10; F16L 3/137; F16B 9/00

(52) U.S. Cl. CPC F16L 5/10; F16B 9/07; F16L 3/137

(57) ABSTRACT

A grommet for surrounding a conduit received through a hole in a part, including a grommet body configured for engagement with a perimeter of the hole in the part and defining a closed or substantially closed perimeter, and a plurality fingers, the fingers extending axially from the grommet body and being circumferentially spaced from one another, each of the fingers being elongated and having a free end axially spaced from the grommet body. An assembly includes the part, the grommet, the conduit, and an adjustable length fastener spaced from the part, the adjustable length fastener forming a loop having an adjustable perimeter, the conduit and the fingers extending within the loop, the adjustable length fastener retaining the fingers against the outer surface of the conduit. A method of supporting a conduit within a hole through a part is also discussed.

### CROSS-REFERENCE TO RELATED APPLICATIONS

This application claims priority from U.S. provisional application No. 62/258,690 filed Nov. 23, 2015, the entire contents of which are incorporated by reference herein.

### TECHNICAL FIELD

The application relates generally to the securing of conduits through structural parts, and more particularly, to the securing of aircraft conduits through aircraft structural parts.

### BACKGROUND OF THE ART

In aircraft, when a conduit goes through a structural part, metal brackets are often used for keeping the duct in place. These metal brackets are attached to the structural part, for example with fasteners penetrating in the part. In some instances it may be required to support the conduit around its entire circumference; larger conduits can require brackets and/or clamps having a relatively large size to allow adequate circumferential support without crushing the conduit. Brackets can provide undesirable weight and cost, and the penetrating fasteners attaching the brackets to the structural part may create a risk of fatigue failure and/or be difficult to access for installation or maintenance.

Similar concerns may be applicable to conduits extending through other types of structures.

### SUMMARY

In one aspect, there is provided a grommet for surrounding a conduit received through a hole in a part, the grommet comprising: a grommet body configured for engagement with a perimeter of the hole in the part, the grommet body defining a closed or substantially closed perimeter; and a plurality fingers, the fingers extending axially from the grommet body and being circumferentially spaced from one another, each of the fingers being elongated and having a free end axially spaced from the grommet body.

In a particular embodiment, the grommet body is formed by an elongated strap configurable between a flat configuration and an annular configuration where opposing ends thereof are connected to or adjacent to one another to define the closed or substantially closed perimeter.

In a particular embodiment, the free end of each of the fingers includes a protuberance extending radially outwardly relative to an adjacent portion of the finger.

In a particular embodiment, the grommet further comprises: a first row of first projections extending radially outwardly from the grommet body, the first projections being circumferentially spaced from one another; and a second row of second projections extending radially outwardly from the grommet body, the second projections being circumferentially spaced from one another; wherein the first and second rows are axially spaced from one another such as to define an annular space therebetween, the annular space being configured to receive the part around the perimeter of the hole. The first projections may extend within a first plane and the second projections may extend within a second plane, the first and second planes being perpendicular to an axial direction of the closed or substantially closed perimeter.

In a particular embodiment, the grommet further comprises a plurality of snap elements connected to the grommet body opposite the plurality of fingers, the snap elements being circumferentially spaced from one another, each of the snap elements being deformable between a first configuration where the snap elements extend within the annular space between the first and second rows and a second configuration where the snap element is out of the annular space between the first and second rows. Each of the snap elements may have a curved configuration with a concave side facing the grommet body and a free end located radially outwardly of the grommet body, wherein in the first configuration the free end protrudes within the annular space between the first and second rows.

In a particular embodiment, the first row is adjacent a connection point between the plurality of fingers and the grommet body and the second row is spaced further away from the plurality of fingers than the first row, each of the snap elements being circumferentially aligned with a space between adjacent ones of the second projections, the free end of each of the snap elements in the second configuration being located between the adjacent ones of the second projections.

In a particular embodiment, each of the snap elements includes a first portion extending radially outwardly and axially away from the grommet body, a second portion extending radially outwardly from the first portion and axially toward the grommet body, and a third portion extending radially inwardly from the second portion and axially toward the grommet body, the third portion defining the free end of the snap element.

In a particular embodiment, each of the fingers includes a first inclined portion extending axially away from the grommet body and radially inwardly therefrom, a second portion extending from the first portion along an axial direction of the grommet body, and the free end extending from the second portion, the free end being curved.

In another aspect, there is provided an assembly comprising: a part having a hole defined therethrough, the part having first and second opposed outer surfaces and an inner surface extending between the first and second outer surfaces, the inner surface defining a perimeter of the hole; a grommet having an grommet body engaged with the inner surface of the part and a plurality fingers extending axially away from the grommet body and from the part, the fingers circumferentially spaced from one another; a conduit extending through the hole, the grommet body being located between an outer surface of the conduit and the inner surface of the part, the plurality of fingers extending in contact with the outer surface of the conduit; and an adjustable length fastener spaced from the part, the adjustable length fastener forming a loop having an adjustable perimeter, the conduit and the fingers extending within the loop, the adjustable length fastener retaining the fingers against the outer surface of the conduit.

In a particular embodiment, a free end of the fingers includes a protuberance extending radially outwardly relative to an adjacent portion of the finger, the loop being received against the adjacent portion, the protuberance defining a stop preventing the loop from moving axially away from the part further than the protuberance.

In a particular embodiment, the assembly further comprises: a first row of first projections extending radially outwardly from the grommet body, the first projections being circumferentially spaced from one another and extending in contact with the first outer surface of the part; and a second row of second projections extending radially outwardly from the grommet body, the second projections being circumferentially spaced from one another and extending adjacent the second outer surface of the part.

In a particular embodiment, the assembly further comprises a plurality of snap elements connected to the grommet body opposite the plurality of fingers, the snap elements being circumferentially spaced from one another, each of the snap elements having a curved configuration with a concave side facing the grommet body and a free end located radially outwardly of the grommet body, each of the snap elements extending from the grommet body away from the part and then back toward the part with the free end biased against the second outer surface of the part.

In a particular embodiment, the first row of first projections is adjacent a connection point between the plurality of fingers and the grommet body and the second row of second projections is spaced further away from the plurality of fingers than the first row of first projections, each of the snap elements being circumferentially aligned with a space between adjacent ones of the second projections, the free end of each of the snap elements being located between the adjacent ones of the second projections.

In a particular embodiment, each of the snap elements includes a first portion extending radially outwardly and axially away from the grommet body, a second portion extending radially outwardly from the first portion and axially toward the grommet body, and a third portion extending radially inwardly from the second portion and axially toward the grommet body, the third portion defining the free end of the snap element.

In a particular embodiment, each of the fingers is biased against the outer surface of the conduit independently of the adjustable length fastener.

In a particular embodiment, the grommet body is formed by an elongated strap curved such that opposing ends thereof are connected to one another.

In a further aspect, there is provided a method of supporting a conduit within a hole defined through a part, the method comprising: engaging a body of a grommet against an inner surface of the part defining a perimeter of the hole; inserting the conduit within the body; engaging a loop of an adjustable length fastener around the conduit and around a plurality of fingers of the grommet, the fingers extending from the body away from the part, the fingers being circumferentially spaced around the conduit; and tightening the loop to press the plurality of fingers against the conduit.

In a particular embodiment, engaging the body includes retaining the body against the inner surface with a snap fit.

In a particular embodiment, engaging the body further includes providing an adhesive between the body and the inner surface.

### DESCRIPTION OF THE DRAWINGS

Reference is now made to the accompanying figures in which:

FIG. 1 is a schematic tridimensional view of an aircraft according to a particular embodiment;

FIG. 2 is a schematic tridimensional view of an assembly including a grommet according to a particular embodiment;

FIG. 3 is a schematic tridimensional view of the grommet of FIG. 2, shown in its flat configuration;

FIG. 4 is a schematic cross-sectional view of the grommet taken along lines 4-4 of FIG. 3, with a snap element thereof in a first (free) configuration; and

FIG. 5 is a schematic cross-sectional view of the grommet taken along lines 5-5 of FIG. 3, with the snap element in a second (installed) configuration.

### DETAILED DESCRIPTION

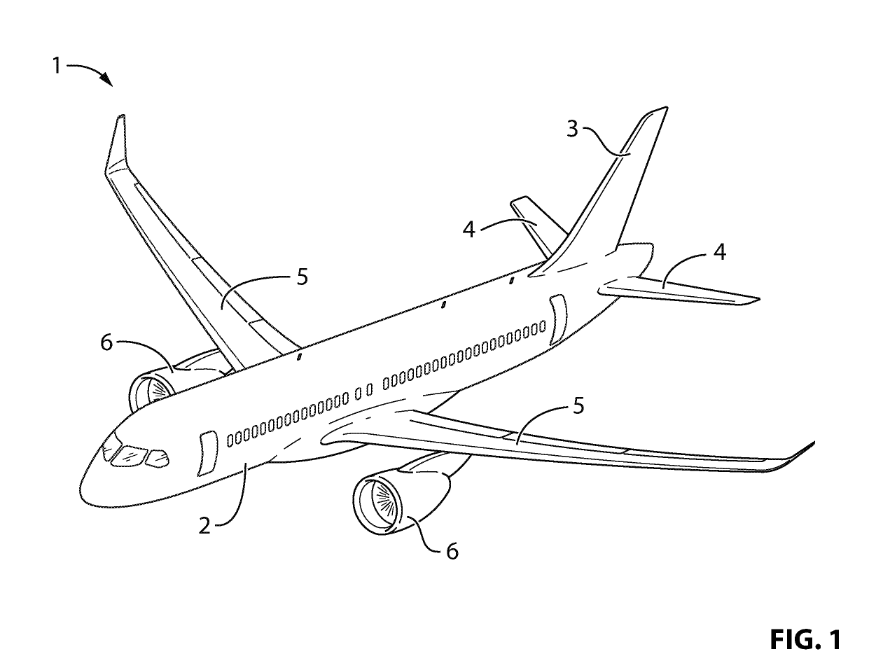

Referring to the drawings and more particularly to FIG. 1, an aircraft is shown at 1, and is generally described to illustrate some components for reference purposes in the present disclosure. The aircraft 1 has a fuselage 2 having a fore end at which a cockpit is located, and an aft end supporting a tail assembly, with the cabin generally located between the cockpit and the tail assembly. The tail assembly comprises a vertical stabilizer 3 with a rudder, and horizontal stabilizers 4 with elevators. The tail assembly has a fuselage-mounted tail, but other configurations may also be used for the aircraft 1, such as cruciform, T-tail, etc. Wings 5 project laterally from the fuselage. The aircraft 1 has engines 6 supported by the wings 5, although the engines 6 could also be mounted to the fuselage 2. The aircraft 1 is shown as a jet-engine aircraft, but may also be a propeller aircraft.

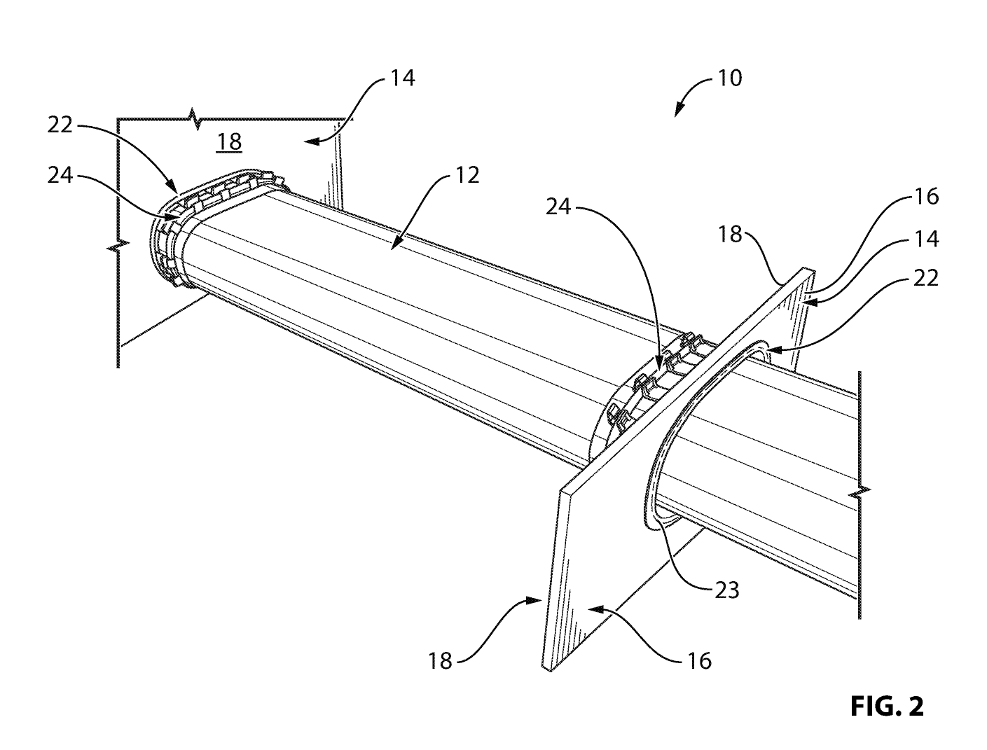

The aircraft includes a number of conduits extending therein, some of which extend through one or more structural parts, for example in the fuselage 2 or in the wings 5. Referring to FIG. 2, an example of an assembly 10 including a conduit 12 extending through two structural parts 14 is shown. In a particular embodiment, the conduit 12 is an environmental control system (ECS) duct, configured to circulate pressurized air to the cabin, and the structural parts 14 are floor beams forming part of the fuselage 2. It is however understood that the particular conduit 12 and structural parts 14 shown are provided as an example only, and that variations are possible.

Accordingly, it is understood that the term “conduit” is intended herein to include any elongated tubular component extending through a structure, including such components having circular cross-sections and other suitable (e.g. oval) cross-sections, and used for example to circulate a fluid (e.g. air, water, lubricant, coolant) or electricity, including, but not limited to, pipes, wires, wire bundles, ducts, cables. For example, in a particular embodiment, the conduit is a light weight conduit not essential for flight.

It is also understood that the terms “structural part” and “part” are intended herein to include any element in which a hole may be defined to circulate a conduit therethrough, including, but not limited to, any structural element forming part of the fuselage 2 (whether part of its outer wall or of its internal structure, e.g. floor or bulkhead), or any structural element forming part of the wings 5. Examples of such structural elements include, but are not limited to, panels, beams, stringers, ribs, spars, frames, bulkhead panels and secondary structures.

In FIG. 2, the conduit 12 is shown as extending through two structural parts 14. It is however understood that the conduit 12 may extend through a single part, or through more than two parts. The assembly of the conduit within one of the parts will be described herein, with the understanding that a similar assembly may be provided for each of the parts through which the conduit extends.

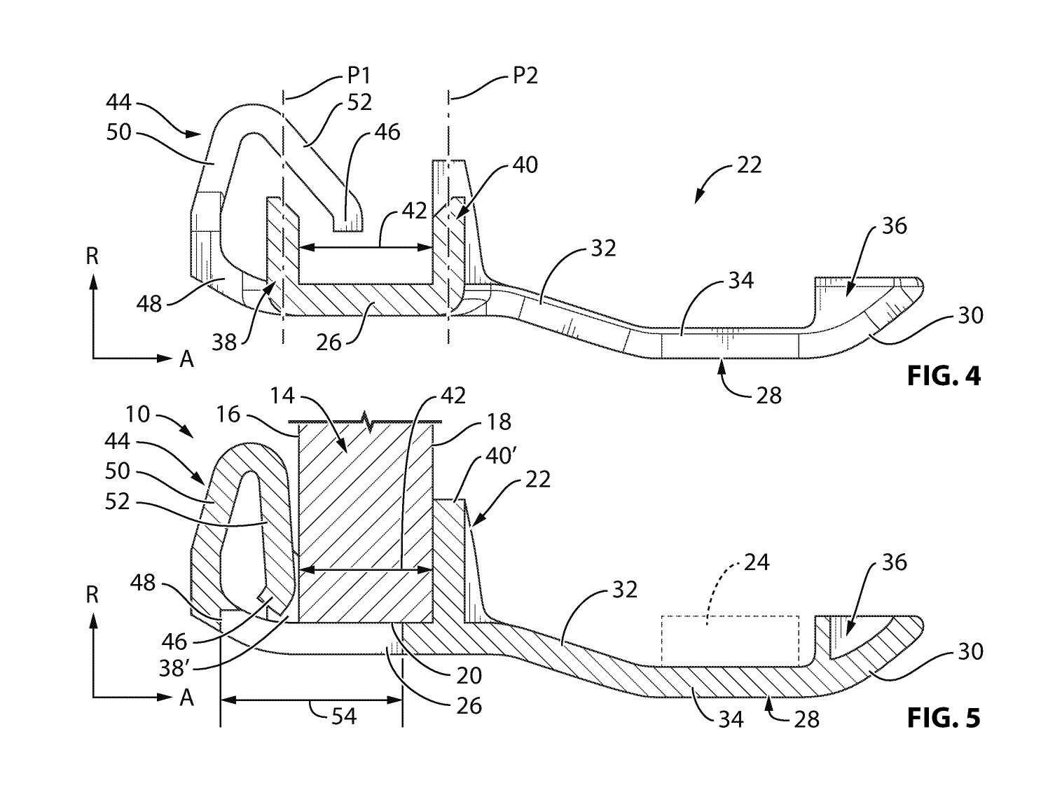

Each part 14 has opposed outer surfaces 16, 18, and an inner surface 20 (see FIGS. 4-5) defining the perimeter of the hole and extending between the opposed outer surfaces 16, 18. A grommet 22 is provided within the hole and engaged to the part 14 to support the conduit 12 extending therethrough. The grommet 22 is attached to the conduit 12 through an adjustable length fastener 24 (also represented in dotted lines in FIG. 5) defining a loop having an adjustable perimeter.

In a particular embodiment, the adjustable length fastener 24 is a cable tie strap (tie-wrap), including a flexible tape section with teeth and a head with a pawl. The free end of the flexible tape section is inserted in the head so that as the free end of the tape section is pulled through the pawl, the perimeter of the loop defined by the cable tie reduces. The teeth engaging the pawl form a ratchet so that the perimeter of the loop cannot be increased without damaging the cable tie strap. Such a fastener is typically cut when it needs to be removed.

Is it understood that other types of adjustable length fasteners 24 may be used. For example, fasteners forming a loop with a perimeter which may be reduced or increased without damage to the fastener may be used. Examples of such fasteners include, but are not limited to, a strap having opposed ends with complementary holes and protrusions engageable in different relative positions to form a loop with different perimeters, a strap having ends adhesively engageable to one another to form a loop, two or more elements engageable to one another to form a loop, etc.

Referring to FIGS. 4-5, the grommet has a body 26 configured for engagement with the inner surface 20 of the hole of the part 14. The grommet body 26 is annular, i.e. it defines a closed or substantially closed perimeter surrounding a central opening. In the embodiment shown in FIG. 2, the grommet body 26 has an oval shape. It is understood that other shapes are alternately possible, including, but not limited to, a circular shape.

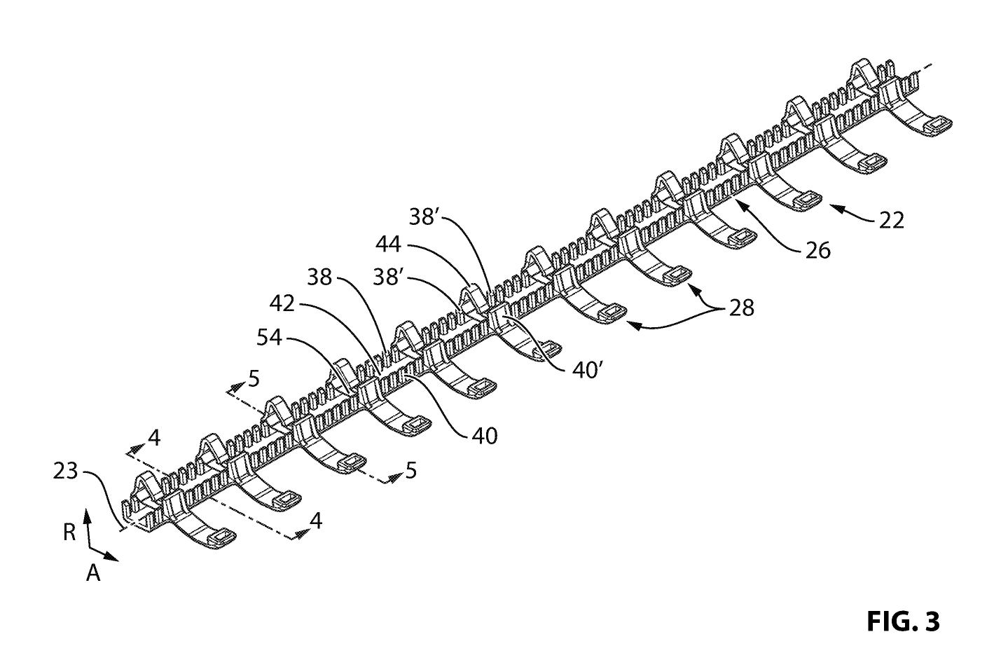

In the embodiment shown and referring particularly to FIG. 3, the grommet body 26 is formed by an elongated, flexible strap having a relatively flat configuration. When positioned within a hole of a structure, the strap is curved such that the longitudinal axis 23 of the body 26 becomes curved and oriented circumferentially, and the strap's opposing ends are connected to one another or adjacent one another, to obtain the configuration defining the closed or substantially closed perimeter shown in FIG. 2. In the embodiment shown, the grommet 22 is of a type referred to as “caterpillar” grommet. The grommet body 26 is configured to surround the conduit 12 within the hole of the part 14. Although the grommet body 26 is formed of a single strap, it is understood that alternately, two or more straps may be connected end to end to define the complete loop surrounding the conduit 12.

Alternately, the grommet body 26 may be provided in a configuration which is already annular, defining a closed or open perimeter.

The terms “axial”, “radial” and “circumferential” and related terms are intended herein to respectively refer to the axial direction A, radial direction R, and circumferential direction of the closed or substantially closed perimeter formed by the grommet body 26 when configured annularly. The circumferential direction thus corresponds to that of the longitudinal axis 23 of the grommet body 26 shown in FIG. 3. The orientation of the elements will be described herein in relation to the directions of the closed or substantially closed perimeter, for clarity and consistency.

Referring particularly to FIGS. 4-5, the grommet 22 further includes a plurality of elongated fingers 28 extending axially from the grommet body 26. The fingers 28 are circumferentially spaced from one another; in a particular embodiment, the fingers 28 are equally spaced apart from one another around the perimeter of the grommet body 26. Each finger 28 has a free end 30 axially spaced from the grommet body 26.

The fingers 28 are configured to extend away from the part 14 and around the conduit 12, and to be received within the loop of the adjustable length fastener 24, such as to be retained against the conduit 12 by the fastener 24. In the embodiment shown, each finger 28 includes a first inclined portion 32 extending axially away from the grommet body 26, and angled with respect to the axial direction A such as to extend further radially inwardly as it extends away from the grommet body 26. Each finger also includes a second portion 34 extending from the first portion 32 along the axial direction A. The second portion 34 of each finger 28 is thus slightly radially inwardly offset (i.e. offset along radial direction R) with respect to the grommet body 26, such as to be pressed against the outer surface of the conduit 12 when the conduit 12 is received through the grommet 22. Each finger 28 is thus biased against the outer surface of the conduit 12 independently of the adjustable length fastener 24. Alternately, the fingers 28 may be configured without this independent bias.

The free end 30 of each finger 28 extends from the second portion 34. In the embodiment shown, the free end 30 is curved with its convex side facing radially inwardly. The free end 30 includes a protuberance 36 protruding radially outwardly relative to the adjacent second portion 34 of the finger 28. The loop of the adjustable length fastener 24 is received around the second portion 34 of the fingers 28 (see FIG. 5), and the protuberance 36 defines a stop preventing the loop of the fastener 24 from moving axially away from the part 14 further than the protuberance 36. Other configurations are also possible.

The grommet body 26 can be engaged against the inner surface 20 of the part 14 through any adequate type of fastening elements, with or without the use of adhesive. In the embodiment shown, the grommet 22 includes projections 38, 40 extending radially outwardly from the grommet body 26, disposed in two axially spaced apart rows. The projections 38, 40 of each row are circumferentially spaced apart from one another. An annular space 42 is defined between the two rows of projections 38, 40; this annular space 42 is configured (e.g. sized) to be able to receive the part 14 therein around the perimeter of the hole, such that the part is sandwiched between the two rows of projections 38, 40 (see FIG. 5). In the embodiment shown, each row of projections 38, 40 is located in a respective plane P₁, P₂ extending perpendicularly to the axial direction A of the grommet body 26. As can be seen in FIG. 5, the projections 38, 40 of each row are in contact with a respective one of the outer surfaces 16, 18 of the part. The projections 38, 40 may be biased inwardly towards the annular space 42, at an angle in relation to the radial direction R, so as to better grip the part 14 received therein. Alternately, only projections 40 may be in contact with the respective outer surface 18 of the part such that the annular space 42 has a dimension greater than the thickness of the part 14—the grommet body 26 can thus be used with parts having different thicknesses.

In a particular embodiment, the grommet 22 includes snap elements 44 to retain the grommet body 26, at least temporarily, against the inner surface 20 of the part 14 and against the outer surface 18 opposed to the snap elements 44; “temporary” retention may refer to retention until a moment when another retention element is effective, for example until an adhesive disposed between the grommet body 26 and the inner surface 20 and/or between the projections 40, 40′ and the outer surface 18 is cured.

The snap elements 44 are connected to the grommet body 26 opposite the fingers 28, and are circumferentially spaced from one another. As can be seen in FIG. 3, each snap element 44 is aligned with a circumferential space between adjacent projections 38 of the adjacent row, such as to be able to be received therebetween.

In the embodiment shown in FIG. 3, each snap element 44 is circumferentially aligned with a respective finger 28. The circumferential space between adjacent projections 38 is greater for the projections 38′ between which the snap element 44 is received than between the other adjacent projections 38 of the row. The projections 40′ of the other row which are circumferentially aligned with one of the fingers 28 (and thus facing one of the snap elements 44) are enlarged both circumferentially and radially with respect to the other projections 40 of the row, for example to provide for a good surface adhesion between the projections 40′ and the surface 18 of the part. Other configurations are also possible.

Referring back to FIGS. 4-5, each snap element 44 is curved, with its concave side facing the grommet body 26. Each snap element 44 has a free end 46 located radially outwardly of the grommet body 26, and is deformable between a first (free) configuration where the free end 46 protrudes within the annular space 42 between the first and second rows of projections 38, 40 (see FIG. 4) and a second (installed) configuration where the snap element 44 is out of the annular space 42 (see FIG. 5).

In the second configuration and as can be seen in FIG. 5, the free end 46 of the snap element 44 is received between the adjacent projections 38′, and the snap element 44 is biased against the adjacent outer surface 16 of the part 14; the part 14 is thus pressed between the snap elements 44 and the projections 40 of the opposed row, including the enlarged projection 40′ facing each of the snap elements 44. The snap elements 44 thus provide a snap engagement of the grommet 22 with the part 14 around the perimeter of the hole. It is understood that the shape of the snap element 44 in its deformed configuration may be different than that shown in FIG. 5, which is provided as an example only.

Referring to FIG. 4, in the embodiment shown, each snap element 44 includes a first inclined or curved portion 48 extending radially outwardly and axially away from the grommet body 26, a second inclined or curved portion 50 extending radially outwardly from the first portion 48 and axially toward the grommet body 26, and a third portion 52 connected to the second portion 50 by a curve and extending radially inwardly from the second portion 50 and axially toward the grommet body 26, with the third portion 52 defining the free end 46. Other configurations are also possible.

In the embodiment shown and with reference to FIGS. 3 and 5, the grommet body 26 and first portion 48 of the snap element 44 have an opening 54 defined therethrough, for example to facilitate manufacturing and/or for weight reduction.

In a particular embodiment, the snap elements 44 are used in combination with adhesive disposed between the grommet body 26 and the inner surface 20 of the part 14 and between the projections 40, 40′ and the outer surface 18 of the part 14.

Alternately, the snap elements 44 may be omitted; for example, the fit between the part 14 and the annular space 42 defined between the rows of projections 38, 40 may be sufficiently tight to retain the grommet body 26, at least temporarily, against the inner surface 20.

In a particular embodiment, the grommet 22 is monolithic and made of a suitable polymer, including, but not limited to, nylon (polyamide).

In use, the grommet body 26 is thus engaged against the inner surface 20 of the part defining the hole perimeter, and the conduit 12 is inserted within the opening defined by the grommet body 26. The loop of the adjustable length fastener 24 is engaged around the conduit 12 and around the fingers 28 of the grommet 22. The loop of the adjustable length fastener 24 is tightened to press the fingers 28 against the conduit 12.

In a particular embodiment, the grommet body 26 is retained against the inner surface 20 and outer surface 18 of the part 14 with a snap fit, for example through the use of the snap elements 44 shown. As mentioned above, a suitable adhesive may be provided between the grommet body 26 and the inner surface 20 of the part 14 and/or between the projections 40, 40′ and the outer surface 18 of the part.

In a particular embodiment, the assembly 10 including the grommet 22 and adjustable length fastener 24 allows for cost and/or weight savings in the support of conduits 12, as compared to prior metallic brackets and penetrating fasteners. In a particular embodiment, the assembly 10 allows for the elimination of the use of penetrating fasteners to retain the conduits, which reduces the risk of fatigue failure in the part. In a particular embodiment, the assembly 10 allows for shorter installation times and/or easier replacement and/or improved accessibility, as compared to prior metallic brackets and penetrating fasteners.

Although the assembly 10 has been shown as used in an aircraft 1, it is understood that the assembly 10 can be used in any structure where conduits are received through holes in parts, including, but not limited to, any type of vehicle requiring installation of conduit(s) through their structure, for example trains and subway vehicles.

It is understood that any combination or sub-combination of the elements of the different embodiments is within the scope of this disclosure. While the methods and systems described herein have been described and shown with reference to particular steps performed in a particular order, it will be understood that these steps may be combined, sub-divided or reordered to form an equivalent method without departing from the teachings of the present invention. Accordingly, the order and grouping of the steps is not a limitation of the present invention.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

1. A grommet for surrounding a conduit received through a hole in a part, the grommet comprising:
a grommet body configured for engagement with a perimeter of the hole in the part, the grommet body defining a closed or substantially closed perimeter; and
a plurality fingers, the fingers extending axially from the grommet body and being circumferentially spaced from one another, each of the fingers being elongated and having a free end axially spaced from the grommet body, the free end of each of the fingers includes a protuberance extending radially outwardly relative to an adjacent portion of the finger.

2. The grommet as defined in claim 1, wherein the grommet body is formed by an elongated strap configurable between a flat configuration and an annular configuration where opposing ends thereof are connected to or adjacent to one another to define the closed or substantially closed perimeter.

3. (canceled)

4. The grommet as defined in claim 1, further comprising:
a first row of first projections extending radially outwardly from the grommet body, the first projections being circumferentially spaced from one another; and
a second row of second projections extending radially outwardly from the grommet body, the second projections being circumferentially spaced from one another;
wherein the first and second rows are axially spaced from one another such as to define an annular space therebetween, the annular space being configured to receive the part around the perimeter of the hole.

5. The grommet as defined in claim 4, wherein the first projections extend within a first plane and the second projections extend within a second plane, the first and second planes being perpendicular to an axial direction of the closed or substantially closed perimeter.

6. The grommet as defined in claim 4, further comprising a plurality of snap elements connected to the grommet body opposite the plurality of fingers, the snap elements being circumferentially spaced from one another, each of the snap elements being deformable between a first configuration where the snap elements extend within the annular space between the first and second rows and a second configuration where the snap element is out of the annular space between the first and second rows.

7. The grommet as defined in claim 6, wherein each of the snap elements has a curved configuration with a concave side facing the grommet body and a free end located radially outwardly of the grommet body, wherein in the first configuration the free end protrudes within the annular space between the first and second rows.

8. The grommet as defined in claim 7, wherein the first row is adjacent a connection point between the plurality of fingers and the grommet body and the second row is spaced further away from the plurality of fingers than the first row, each of the snap elements being circumferentially aligned with a space between adjacent ones of the second projections, the free end of each of the snap elements in the second configuration being located between the adjacent ones of the second projections.

9. The grommet as defined in claim 7, wherein each of the snap elements includes a first portion extending radially outwardly and axially away from the grommet body, a second portion extending radially outwardly from the first portion and axially toward the grommet body, and a third portion extending radially inwardly from the second portion and axially toward the grommet body, the third portion defining the free end of the snap element.

10. The grommet as defined in claim 1, wherein each of the fingers includes a first inclined portion extending axially away from the grommet body and radially inwardly therefrom, a second portion extending from the first portion along an axial direction of the grommet body, and the free end extending from the second portion, the free end being curved.

11. An assembly comprising:
a part having a hole defined therethrough, the part having first and second opposed outer surfaces and an inner surface extending between the first and second outer surfaces, the inner surface defining a perimeter of the hole;
a grommet having an grommet body engaged with the inner surface of the part and a plurality of fingers extending axially away from the grommet body and from the part, a free end of the fingers including a protuberance extending radially outwardly relative to an adjacent portion of the finger, the plurality of fingers circumferentially spaced from one another;
a conduit extending through the hole, the grommet body being located between an outer surface of the conduit and the inner surface of the part, the plurality of fingers extending in contact with the outer surface of the conduit; and
an adjustable length fastener spaced from the part, the adjustable length fastener forming a loop having an adjustable perimeter, the conduit and the fingers extending within the loop, the adjustable length fastener retaining the fingers against the outer surface of the conduit.

12. The assembly as defined in claim 11, wherein the loop received against the adjacent portion, the protuberance defining a stop preventing the loop from moving axially away from the part further than the protuberance.

13. The assembly as defined in claim 11, further comprising:
a first row of first projections extending radially outwardly from the grommet body, the first projections being circumferentially spaced from one another and extending in contact with the first outer surface of the part; and
a second row of second projections extending radially outwardly from the grommet body, the second projections being circumferentially spaced from one another and extending adjacent the second outer surface of the part.

14. The assembly as defined in claim 11, further comprising a plurality of snap elements connected to the grommet body opposite the plurality of fingers, the snap elements being circumferentially spaced from one another, each of the snap elements having a curved configuration with a concave side facing the grommet body and a free end located radially outwardly of the grommet body, each of the snap elements extending from the grommet body away from the part and then back toward the part with the free end biased against the second outer surface of the part.

15. The assembly as defined in claim 14, wherein the first row of first projections is adjacent a connection point between the plurality of fingers and the grommet body and the second row of second projections is spaced further away from the plurality of fingers than the first row of first projections, each of the snap elements being circumferentially aligned with a space between adjacent ones of the second projections, the free end of each of the snap elements being located between the adjacent ones of the second projections.

16. The assembly as defined in claim 14, wherein each of the snap elements includes a first portion extending radially outwardly and axially away from the grommet body, a second portion extending radially outwardly from the first portion and axially toward the grommet body, and a third portion extending radially inwardly from the second portion and axially toward the grommet body, the third portion defining the free end of the snap element.

17. The assembly as defined in claim 11, wherein each of the fingers is biased against the outer surface of the conduit independently of the adjustable length fastener.

18. The assembly as defined in claim 11, wherein the grommet body is formed by an elongated strap curved such that opposing ends thereof are connected to one another.

19. A method of supporting a conduit within a hole defined through a part, the method comprising:
engaging a body of a grommet against an inner surface of the part defining a perimeter of the hole;
inserting the conduit within the body;
engaging a loop of an adjustable length fastener around the conduit and around a plurality of fingers of the grommet, the fingers extending from the body away from the part, a free end of the fingers including a protuberance extending radially outwardly relative to an adjacent portion of the finger, the plurality of fingers being circumferentially spaced around the conduit; and
tightening the loop to press the plurality of fingers against the conduit.

20. The method as defined in claim 19, wherein engaging the body includes retaining the body against the inner surface with a snap fit.

21. The method as defined in claim 20, wherein engaging the body further includes providing an adhesive between the body and the inner surface.

22. The grommet as defined in claim 1, wherein an adjustable length fastener is received against the adjacent portion of the finger, the protuberance defining a stop preventing the loop from moving axially away from the part further than the protuberance.
